(19) United States
(12) Patent Application Publication
(10) Pub. No.: US 2006/0155763 A1
(43) Pub. Date: Jul. 13, 2006

(54) Systems and methods for providing an interface for interacting with a loop

(75) Inventors: Prescott V. Lee, Menlo Park, CA (US); Kyle S. Mashima, Menlo Park, CA (US)

Correspondence Address: CARR & FERRELL LLP, 2200 GENG ROAD, PALO ALTO, CA, 94303, US

(73) Assignee: FilmLoop, Inc.

(21) Appl. No.: 11/173,552

(22) Filed: Jul. 1, 2005

Related U.S. Application Data
(60) Provisional application No. 60/644,129, filed on Jan. 13, 2005.
(60) Provisional application No. 60/644,254, filed on Jan. 13, 2005.

(51) Int. Cl. G06F 17/30

(52) U.S. Cl. 707/104.1

(57) ABSTRACT

A system and method for is provided for. The system comprises a media engine which provides a display box is configured for displaying one or more loops comprised of at least one item of media. One or more frame differentiators within the display box are configured for defining the at least one item of media within the one or more loops. A menu is configured for providing options associated with the one or more loops. Player controls are configured for manipulating the one or more loops.

### CROSS-REFERENCE TO RELATED APPLICATIONS

The present application claims the benefit and priority of U.S. provisional patent application Ser. No. 60/644,254 filed on Jan. 13, 2005 and entitled “Systems and Methods for One Click Photo Sharing,” and U.S. provisional patent application Ser. No. 60/644,129, filed on Jan. 13, 2005 and entitled “Systems and Methods for Drag and Drop Loops,” which are herein incorporated by reference.

This application is related to co-pending U.S. application Ser. No. ______, entitled “Systems and Methods for Providing Loops,” filed on Jul. 1, 2005, co-pending U.S. application Ser. No. ______, entitled “Systems and Methods for Single Act Media Sharing,” filed on Jul. 1, 2005, co-pending U.S. application Ser. No. ______, entitled “Systems and Methods for Single Input Installation of an Application,” filed on Jul. 1, 2005, co-pending U.S. application Ser. No. ______, entitled “Systems and Methods for Sharing Loops,” filed on Jul. 1, 2005, and co-pending U.S. application Ser. No. ______, entitled “Loop Channels,” filed on Jul. 1, 2005, which are herein incorporated by reference.

### BACKGROUND OF THE INVENTION

1. Field of the Invention

The present invention relates generally to media, and more particularly to systems and methods for providing an interface for interacting with a loop.

2. Description of Related Art

Conventionally, in order to organize data, such as documents, images, pictures, audio files, and other media, a user typically creates a file system for storing and locating these items. Related items are often stored in the same folder and organized by a file directory. The file directory allows the user to store and locate items according to a tree system, where files are stored within folders, which may be within other folders, and so on.

When the user elects to view the items, the user can browse the file directory in order to locate the particular item and open the item for display. If the user wants to group several items together, the user can store the items as files within the same folder and open each file in order to view the file contents. Another way the user can group the items together is by saving the items to one file, as a single document. In this case, the user needs to open the single file to display the contents of the single document. The user can then scroll down the single document to display the contents.

With the advent of digital cameras, users store numerous pictures on their computers and related computing devices. Because file directories for storing text documents and other types of items are not always as convenient for storing and locating pictures, various software applications have entered the market for organizing pictures on a computing device. These software applications sometimes offer virtual photo albums. A user can click through the photo album to view the pictures on each page of the photo album. The pictures on each page of the photo album are usually organized in the photo album according to the user's preference. If the user wishes to find a particular picture, the user can page through the photo album in search of the picture or enter information about the picture into search parameter fields provided by the software application.

Although various systems are available for organizing the data, interaction with, and display, of the data may be limited.

Therefore, there is a need for a system and method for providing an interface for interacting with a loop.

### SUMMARY OF THE INVENTION

The present invention provides systems and methods for providing an interface for interacting with a loop. In an exemplary method, a media engine for receiving one or more user instructions associated with a loop is provided. The one or more user instructions are received via an interface associated with the media engine. One or more steps are executed to manipulate the loop in response to the one or more user instructions received via the interface.

In an exemplary system for providing an interface for interacting with a loop, a display box is configured for displaying one or more loops comprised of at least one item of media. One or more frame differentiators within the display box are configured for defining the at least one item of media within the one or more loops. A menu is configured for providing options associated with the one or more loops. Player controls are configured for manipulating the one or more loops.

### BRIEF DESCRIPTION OF THE DRAWINGS

FIG. 1 illustrates an exemplary environment for providing a loop;

FIG. 2 illustrates a screen shot of an exemplary loop;

FIG. 3 illustrates a flowchart of an exemplary process for user interaction with an interface;

FIG. 4 illustrates a flowchart of an exemplary process for utilizing user instructions in connection with a loop;

FIG. 5 illustrates a flowchart of an exemplary process for providing an interface for a loop;

FIG. 6 illustrates a schematic diagram for an exemplary media engine;

FIG. 7 illustrates exemplary components associated with the server;

FIG. 8 illustrates an exemplary graphical user interface (GUI) components for providing access to functions related to the media engine;

FIG. 9 illustrates an exemplary drop down menu;

FIG. 10 illustrates an exemplary right click menu associated with an item of media;

FIG. 11 illustrates an exemplary share loop screen for sharing a loop;

FIG. 12 illustrates an exemplary new loop screen for generating a new loop;

FIG. 13 illustrates an exemplary schematic diagram of functions related to a media engine for playing a loop; and

FIG. 14 illustrates an exemplary loop player playing an exemplary loop.

### DESCRIPTION OF EXEMPLARY EMBODIMENTS

A loop is provided for displaying media in association with a computing device of a user. The user may select various media to display using the loop. In one embodiment, the loop comprises a filmloop™. The loop may scroll the media across a display device associated with the computing device, or across any other display associated with any type of device. According to various embodiments, the loop may be assigned an identifier so the media selected by the user for the loop may be shared with one or more other users at one or more other computing devices. When the user drags the media to the loop, the one or more other users that have the loop with the same identifier as the loop of the user on their respective computing devices will receive the media selected by the user. Various other features associated with the loop are described herein.

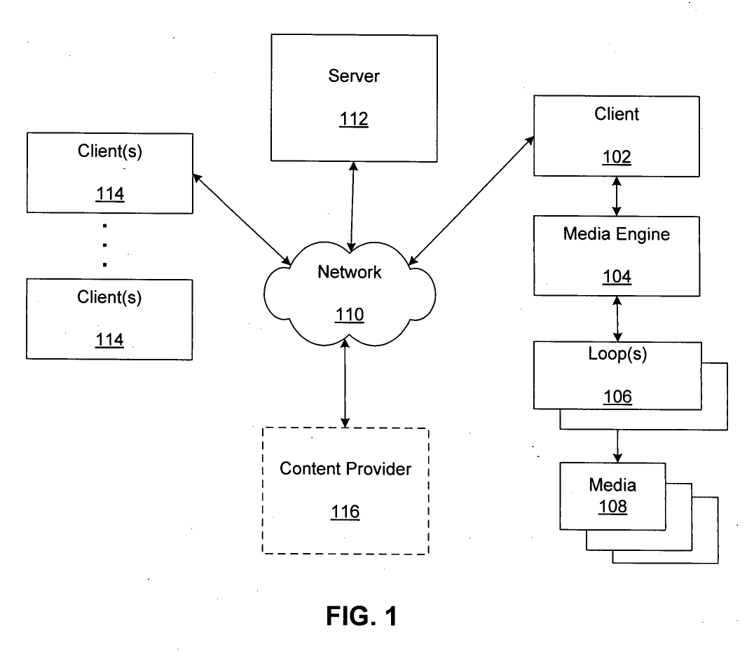

Referring to FIG. 1, an exemplary environment for providing single act media sharing is shown. A user is associated with a client 102. The client 102 includes any type of computing device, such as a cellular telephone, a laptop computer, a personal digital assistant (PDA), and so on. The client 102 has a media engine 104 coupled to the client 102 for creating and/or generating at least one loop 106. The media engine 104 may also play the loop 106. A loop player comprises the graphical representation of the media engine 104. The media engine 104 may be installed onto the client 102 by a single input. The process of installing the media engine 104 by the single input is described in further detail in co-pending U.S. application Ser. No. ______, entitled “Systems and Methods for Single Input Installation of an Application,” filed on Jul. 1, 2005, which is incorporated by reference.

The loop 106 may be comprised of various media 108. The media 108 can include photos, video, audio, images, text, advertisements, and/or any other type of media. The media 108 may appear as one or more items separated by lines, frames, or any other display item for defining the one or more items of the media 108 as separate from each other on the loop. Each frame of the media 108 may itself include moving displays, motion pictures, and so forth.

In one embodiment, the loop 106 scrolls, or is otherwise played, across a display associated with the client 102. In some embodiments, the loop 106 may be manipulated by a user of the client 102 to stop, speed up, or slow down the scrolling of the loop 106, and/or any other type of manipulation. The client 102 may have more than one loop 106 that scrolls across the display at one time. Further, the client 102 may have various loop(s) 106 that play at one time and/or are stored at the client 102 to be played at a time chosen by the user associated with the client 102. The user may also play more than one loop 106, such as playing the loops 106 sequentially, in a single media engine 104.

The media engine 104 may reside on the client 102 or may be otherwise coupled to the client 102. Alternatively, the media engine 104 may be accessible to the client 102 via a network, such as the network 110 shown in FIG. 1. For example, one or more clients 102 may access the media engine 104 via a network in order to create the loop(s) 106, update the loop(s) 106 with additional media 108, remove certain of the media 108 from the loop(s) 106, alter metadata associated with the loop(s) 106, modify the media 108 or metadata associated with the media 108 contained in the loop(s) 106, play the loop(s) 106, and/or perform any other functions utilizing the media engine 104.

In exemplary embodiments, the identifier assigned to the media 108 may be unique within the loop(s) 106. Further, the loop(s) 106 identifier and/or the media 108 identifier is unique within the network 110, according to exemplary embodiments. Any type of identifiers may be assigned to the loop(s) 106 and/or the media 108 according to various embodiments.

The media engine 104 may be utilized, as discussed herein, to create the loop(s) 106 using the media 108. Typically, the user at the client 102 selects the media 108 from files located on the client 102 and/or from media 108 available via the network 110. For example, the user may search for and provide photos found on the Internet to the media engine 104. The media engine 104 receives the media 108 and creates the loop(s) 106 with the media 108. The user can provide more than one item of the media 108 to the media engine 104 for creating or modifying the loop(s) 106.

The user can provide the media 108 by dragging and dropping the media 108 into the media engine 104, by initiating a command that the media 108 be used to create a new loop(s) 106 and/or modify an existing loop 106, and/or any other method of identifying the media 108 as part of the loop(s) 106. In exemplary embodiments, the user can drag a folder including more than one item of the media 108 into the loop(s) 106.

The media engine 104 may assign an identifier to each of the loop(s) 106. The media engine 104 may further assign one or more identifiers to each of the media 108 in the loop 106. For example, the media engine 104 may assign an identifier to a loop 106 that is newly created and may also assign identifiers to each of the media 108 used to create the new loop 106. In one embodiment, the media 108 may be assigned an identifier that is the same or a similar identifier as the loop 106 to which the media 108 belongs.

The loop(s) 106 may be stored by category, dates associated with the media 108 included in the loop(s) 106, metadata associated with the loop(s) 106, or any other criteria. The criteria may be provided to the user as a default and/or the user can specify criteria for storing and/or playing the loop(s) 106. For example, in one embodiment, the user may specify that the loop(s) 106 should be played one at a time, one per day, according to a particular subject matter (e.g. such as family photo loop(s) 106, followed by fan club loop(s) 106, followed by work oriented loop(s) 106), and so forth. Any method for playing the loop(s) 106 is within the scope of various embodiments.

When the user drags and drops one or more items of the media 108 into a particular loop 106, the user is requesting that the media engine 104 modify the particular loop(s) 106 by adding the one or more items of the media 108. Accordingly, the media engine 104 assigns an identifier that is unique within the loop 106 to each of the items of the media 108 dropped by the user.

As discussed herein, the media 108 may be added to more than one loop(s) 106. Accordingly, the media 108 may have more than one identifier associated with the media 108 in order to identify the one or more loop(s) 106 which contain the media 108.

In order to add the media 108 to a loop 106 without using the drag and drop method, the user can employ any method to identify the media 108 to be added and subsequently included in the loop(s) 106 of the media engine 104. For example, the user may copy the media 108 from outside of the loop(s) 106. Subsequently, the user may paste the media 108 into the loop(s) 106. The user can identify the loop 106 according to the loop's 106 identifier, by subject matter, and/or by any other criteria that indicates to the media engine 104 which loop 106 should receive the media 108 being provided by the user.

The user can remove media 108 from a loop 106 by dragging the media 108 out of the loop 106, or identifying to the media engine 104 the media 108 to remove. Any manner of identifying the media 108 the user desires to remove from a loop 106 is within the scope of various embodiments. For instance, the user can highlight the item of the media 108 within the loop 106 and select a remove option from a drop down menu.

The media engine 104 updates the loop 106 to reflect the removal of the media 108. The media engine 104 may remove the identifiers associated with the removed media 108, or the media engine 104 can alter the metadata associated with the removed media 108. Conversely, as discussed herein, the user can add the media 108 back into a loop 106 by dragging and dropping the media 108 into the loop 106 to which the user wishes to add the media 108 or by identifying the media 108 to the media engine 104 that the user wishes to add to the loop 106.

In one embodiment, the identifiers for the loop(s) 106 and/or the media 108 may be assigned and/or maintained by a server 112. The server 112 may be accessed directly by the client 102 or via the network 110. The server 112 can communicate the identifiers for the loop(s) 106 and/or the media 108 to the media engine 104, so the media engine 104 can store and locate the identifiers.

When the user removes, adds, or modifies an item of the media 108 from the loop 106, the server 112 can store and/or track the removals, additions, and/or modifications as updates to the loop 106. The user can also update the loop 106 by making changes to items of the media 108 in the loop 106, or information related to the media 108 in the loop 106. For example, if the user resizes an image of the media 108, the media engine 104 and/or the server 112 can include the resized image as an update to the media 108 in the loop 106. In one embodiment, the server 112 may assign the identifier to the resized image in the media 108 and include the resized image as an update to the media 108 in the loop(s) 106. In another example, if the user changes a text caption of an item of the media 108, the media engine 104 and/or the server 112 can include the changed text caption as an update to the media 108 in the loop 106. Any type of modifications to the media 108, the loop 106, or information related to the media 108 and/or the loop 106 is within the scope of various embodiments.

In one embodiment, the user of the client 102 shares one or more of the loops 106 with one or more users of one or more other clients 114. The other clients 114 may also include one or more media engines for playing the loop(s) 106, creating the loop(s) 106, modifying the loop(s) 106, and so on. The server 112 assigns the same identifier to the loop(s) 106 shared by the client 102 and the client(s) 114.

When a user from the client 102 makes updates to the loop(s) 106 having an identifier shared by the loop(s) 106 at the client(s) 114, the client(s) 114 receive the same updates to the loop(s) 106. As discussed herein, the updates may include any modifications to the loop(s) 106, the media 108 comprising the loop(s) 106, and/or information related to the media 108 and/or the loop(s) 106.

The server 112 can provide the updates to the loop(s) 106 on the client(s) 114 automatically, at any time after the user at the client 102 makes updates to the loop(s) 106. In one embodiment, the server 112 makes requests to the media engine 104 at various times for changes made to the loop(s) 106 at the client 102. In another embodiment, the media engine 104 requests changes, made to the loop(s) 106 at the client 102, from the server 112 at various times. In one embodiment, the server 112 waits for notifications from the client(s) 114 of changes made to the loop(s) 106, then provides the updates to the client(s) 114 that have loops 106 with the same identifiers. Similarly, changes made by the client(s) 114 may be automatically provided to the client 102.

In one embodiment, the media engine 104 or any other component associated with the client 102 assigns a temporary identifier to the media 108 dragged into the loop 106. The client 102 then forwards the media 108 with the temporary identifier to the server 112. The server assigns a permanent identifier to the media 108 and forwards the media 108 with the permanent identifier back to the client 102 and/or to the other client(s) 114 as an update. The temporary identifier associated with the media 108 and/or the permanent identifier associated with the media 108 may further be associated with the identifier assigned to the loop(s) 106. Any type of method for assigning identifiers to the media 108 and/or the loop 106 may be employed by any device according to various embodiments.

The one or more users at the client(s) 114 may also make updates to the loop(s) 106 that have the same identifiers as the loop(s) 106 at the client 102. In one embodiment, the user that originates a shared loop 106 can create permissions for the loop 106. For instance, the originating user may require a password before other users can submit updates to the shared loop(s) 106.

Since the server 112 may automatically distribute the updates to the client(s) 102 and 114 with loop(s) 106 that have shared identifiers, only a single act is required by the user to share the updates to the loop(s) 106 with the users at the client(s) 102 and 114.

In one embodiment, users may subscribe to loop(s) 106. For example, the user at the client 102 may post movie oriented loop(s) 106 to the Internet and other users may subscribe to those movie oriented loop(s) 106 via a registration process. For the users that subscribe to the movie oriented loop(s) 106, updates are received when the originating user makes modifications to the movie oriented loop(s) 106. As discussed herein, a user, vendor, retailer, advertiser, etc. may make loop(s) 106 available for subscription.

Once the loop(s) 106 have been set up by various users and assigned unique identifiers, the server 112 and/or the media engine 104 keeps track of the loop(s) 106 and any changes thereto. Accordingly, since the server 112 automatically distributes, or otherwise distributes, the updates to the client(s) 114 with the loop(s) 106 with shared identifiers based on the user at the client 102 modifying the loop(s) 106 by adding, removing, or changing one or more items of the media 108 within the loop(s) 106, only a single act is required by the user to share the updates to the loop(s) 106 with the users at the client(s) 114.

In one embodiment, master copies of the loop(s) 106 may be stored on the server 112. Accordingly, the user at the client 102 can modify the loop(s) 106 by accessing the server 112. The user may access the server 112 via the network 110 or in any other manner. Alternatively, the server 112 may include an index for locating the various loop(s). In another embodiment, the loop(s) 106 may be stored at the server 112, while the client 102 and/or the client(s) 114 utilize an index to retrieve particular loop(s) 106 when desired. Any storage medium may be utilized for storing the loop(s) 106, copies of the loop(s) 106, metadata, and/or indexes according to various embodiments.

In another embodiment, the server 112 may store the master copies of all the loop(s) 106 for all users along with the identifiers for the loop(s) 106 and the media 108. Accordingly, the server 112 can search for loop(s) 106 based on the identifiers, receive updates to the loop(s) 106 when users associated with the loop(s) 106 makes changes to the loop(s) 106, and automatically distribute updates for the loop(s) 106 to all user associated with the loop(s) 106. In still another embodiment, the loop(s) 106 may be stored on the server 112 in order to minimize storage on the client 102 and/or the client(s) 114, as discussed herein.

In still another embodiment, the server 112 may store versions of the loop(s) 106. Accordingly, the server 112 may maintain various copies of the same loop(s) 106, as different versions. According to another embodiment, the client 102 and/or 114 may store different versions of loop(s) 106 generated by the client 102 or of shared loop(s) 106. The server 112 and/or the client 102 may maintain an index for organizing and tracking the various versions of the loop(s) 106 according to some embodiments.

In one embodiment, a content provider 116 is coupled to the server 112 in order to provide content for the loop(s) 106. The content provider 116 may be directly coupled to the server 114 or the content provider 116 may be coupled to the server 112 via the network 110. In one embodiment, the content provider 116 is coupled to the client 102 and/or the client(s) 114 in order to directly provide the content to the loop(s) stored on the client 102 and/or the client(s) 114.

In exemplary embodiments, the content provider 116 provides advertising content to the loop(s) 106. Alternately, the content provider 116 may provide any type of content. In one embodiment, each of the loops 106 must include at least one item of the content from the content provider 116. More than one content provider 116 may be provided according to various embodiments. Accordingly, the loop(s) 106 may display advertisements or other content along with the other media 108 displayed by the loop(s) 106.

In one embodiment, the content provider 116 can specify how often the content appears within the loop(s) 106. For example, the content provider 116 may specify that the content should appear no less than between every 10^{th} item of media 108 within the loop(s) 106. If the content provider 116 modifies the content, the server 112 or the content provider 116, itself, can distribute the modified content as updates to the loop(s) 106. Accordingly, the modified content replaces the existing content in the loop(s) 106.

In one embodiment, digital content may be emailed to a central authority associated with the loop(s) 106. The central authority may then authenticate the user and distribute the digital content to appropriate loop(s) 106 and/or create new loop(s) 106 based on the digital content. The authentication may be based on username, password, and/or any other information related to the user submitting the digital content.

Although the media engine 104 at the client 102 is described as creating the loop(s) 106 from the media 108, one or more media engines at the client(s) 114 can also provide the media 108 and create the loop(s) 106, modify the loop(s) 106, and so on. In other words the client 102 and the client(s) 114 are capable of performing similar or identical functions with respect to the loop(s) 106.

The process of providing loops is described in further detail in co-pending U.S. application Ser. No. ______, entitled “Systems and Methods for Providing Loops,” filed on Jul. 1, 2005, which is incorporated by reference.

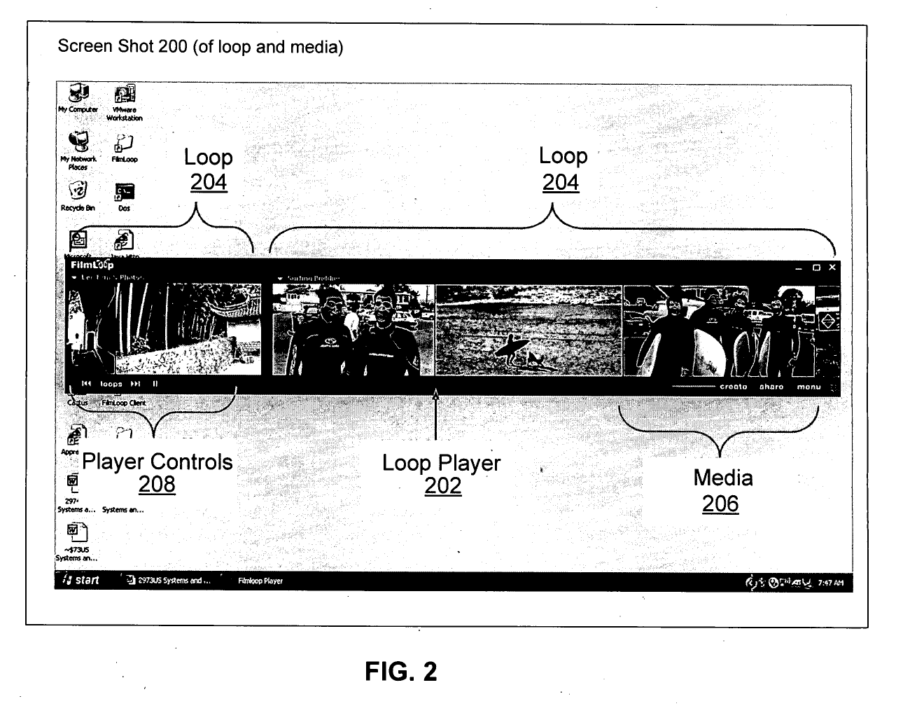

Referring now to FIG. 2, a screen shot of an exemplary loop 204, such as the loop(s) 106 discussed in FIG. 1, in accordance with one embodiment is shown. A loop player 202, such as a graphical representation of the media engine 104 discussed in FIG. 1, includes several loops 204. Each loop 204 includes several items of media 206, such as the one or more items of the media 108 discussed in FIG. 1. The loop player module 202 plays the loop 204 by scrolling the various media 206 across a display device. The display device in FIG. 2 is a desktop display.

In FIG. 2, the loop player 202 is displaying two loops 204, one entitled “Lee Family Photos” and the other entitled “Surfing Buddies.” As shown, one item of the media 206 in the “Surfing Buddies” loop 204 is a picture of four surfers. As discussed herein, various types of media 206 may be included in the loop(s) 204, such as the photograph of the four surfers, advertising content from a content provider, such as the content provider 116 discussed in FIG. 1, and so on. Although FIG. 2 shows two loops 204 adjacent to one another being played by the same loop player 202, a single loop 204 may scroll across a display device associated with a user according to various embodiments. In one embodiment, the user may scroll more than one loop 204 across the display device at different locations on the display device, rather than adjacent loops 204 played in one loop player 202, as discussed herein. Further, more than one loop 204, including adjacent loops 204 played by one loop player 202, may scroll across the display device of the user.

The loop player 202 may scroll the media 206 for the loop 204 across the display device at any speed and/or in any direction. The speed and/or direction may be a default speed, a default direction, and/or a direction and/or speed specified by the user. In one embodiment, the content provider 116 specifies the speed in order to ensure that the content provided appears at specified increments of time. In a further embodiment, the server 112 may also specify the speed and/or the direction.

The user may utilize player controls 208 to adjust the speed, the media 206 to display, and so on. For instance, the user can skip to a previous or next item of the media 206 by utilizing the player controls 208. The user can also pause the scrolling loop(s) 204. Furthermore, the user can stop the loop 204, reduce or expand the size of the loop 204, or minimize the loop 204. In one embodiment, the user may access a master set of controls that control more than one loop 204. In another embodiment, when the user adjusts the player controls 208 associated with the loops 204, other users' loop(s) 204 with the same unique identifier are automatically adjusted as well.

In order to drag the loop 204 and/or the loop player 202 to other areas of the display device, the user can grab the loop player 202 and move it to the desired area using a mouse, a keyboard, or any other coupled control device. The user can incorporate the loop 204 into a second loop, such as the loop(s) 106 discussed herein, by dragging and dropping the loop 204 into the second loop(s).

The user can drag the media 206 from the loop 204 to a second loop to modify the second loop with the media 206 that was dragged into the second loop. In one embodiment, the user may select from a drop down menu to copy and/or move the media 206 to another loop.

In one embodiment, the user may select a single frame from of the media 206, such as the photo of the four surfers, in order to “open” the single frame or load a new loop associated with the single frame. Opening the single frame of the media 206 may enlarge the content that comprises the single frame, display an alternate version of the media 206 that comprises the single frame, make the content available for editing, stop the single frame content from moving (in the event of moving displays), direct the user to a URL address, and so on.

Opening the single frame of the media 108 may also present a new loop, or “sub loop”, associated with the single frame of the media 206. For instance, if a user associated with the loop 204 selects the frame with the photo of the four surfers in the media 206 in the “Surfing Buddies” loop 204, a new loop with more surfing buddies photos and/or content may be revealed. Opening a single frame of the media 206 in a loop 204 having an advertisement may reveal a new loop with content provided solely by a content provider, such as the content provider 116 discussed in FIG. 1. Any type of new loop may be provided as a consequence of opening the single frame of the media 206.

In one embodiment, when the user selects a single frame of the media 206, the loop player 202 makes a request to a client (e.g., such as the client 102 and/or the client(s) 114), to launch a particular application running on the client 102 and/or the client(s) 114. For example, when a particular frame of the media 206 in the loop 204 is selected, the loop player 202 instructs a web browser installed on the client 102 to display a particular web page. The web page may be associated with subject matter for the single frame of the media 206.

In one embodiment, opening a single frame of the media 206 may provide an additional option of sending the single frame of the media 206 to one or more other users. For example, although two users may not share the loop(s) 204 with the same unique identifier, the two users may maintain the loop(s) 204 with similar subject matter. Accordingly, the users may send one or more of the single frames of the media 206 to one another in order to update content, inform one another of advertising, etc.

One or more of the frames of the media 206 can be shared between any users for any reason. In one embodiment, the content provider 116 (FIG. 1) pushes time sensitive information to users of the loop(s) 106 as one or more frames of the media 206. Any type of information may be provided to users of the loop(s) 204, such as news, financial data, sales information, new product offerings, single frames of the media 206 from other loop(s) 204 users, and so on. In one embodiment, the users of the loop(s) 204 can block single frames of the media 206 from being presented.

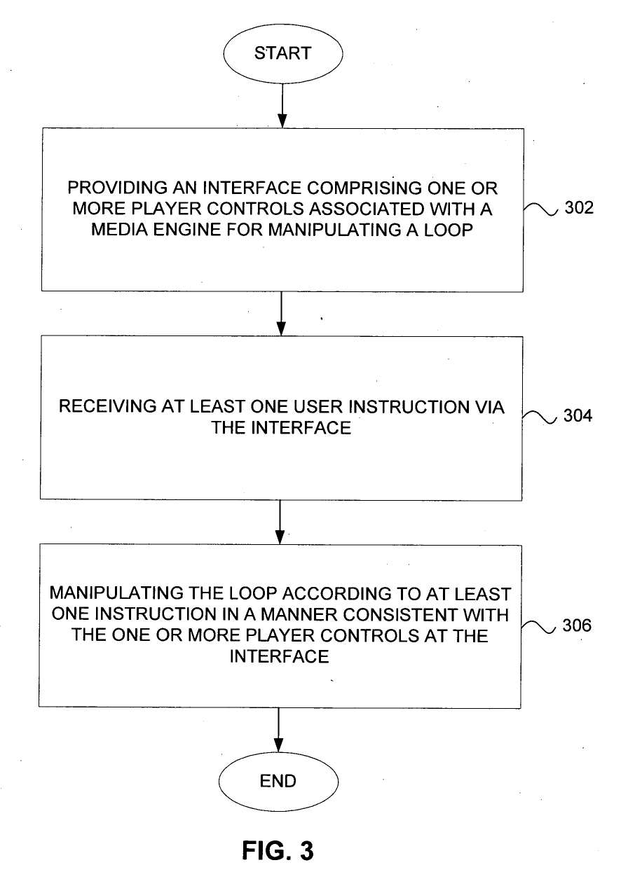

FIG. 3 illustrates a flowchart of an exemplary process for user interaction with an interface. At step 302, an interface comprising one or more player controls associated with a media engine for manipulating a loop is provided. For example, the media engine 104 (FIG. 1) may provide player controls 208 (FIG. 2) for forwarding, reversing, pausing, stopping, and so on the loop(s) 204 (FIG. 2) being displayed by the loop player 202 (FIG. 2). Any type of player controls 208 for manipulating the loop 204 may be provided according to various embodiments.

At step 304, at least one user instruction may be received via the interface. For example, the user may click on a player control button for sending an instruction associated with the player control 208 button (e.g. a player control 208 button for pausing the loop 204). Any instruction may be provided via the interface, according to various embodiments, in association with the player controls 208 or any other mechanism for providing the at least one user instruction.

At step 306, the loop 204 is manipulated according to the at least one instruction in a manner consistent with the one or more player controls 208 at the interface. In response to the user instruction received, the loop 204 is manipulated according to the user instruction. For example, the loop 204 may be reversed in response to receiving the user instruction for reversing the loop 204. The loop 204 may be played backwards or reversed momentarily in order to search for one or more items of media, such as the media 206. The user instruction may be received via buttons on the interface, a drop down menu on the interface, a keyword entry box on the interface, and so on. As discussed herein, in some embodiments, any type of player controls 208 may be provided, such as player controls 208 for manipulating the media 206 within the loop 204, the loop(s) 204, the loop player 202, and so forth.

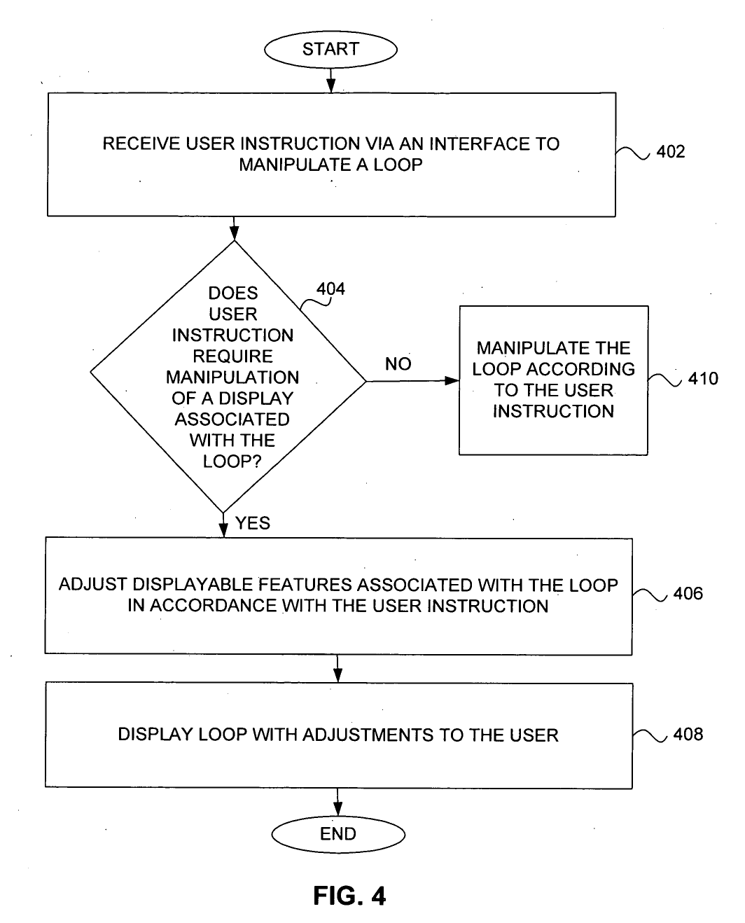

Turning now to FIG. 4, a flowchart of an exemplary process for utilizing user instructions in connection with a loop is shown. At step 402, a user instruction to manipulate the loop 106 (FIG. 1) is received via an interface. As discussed herein, any type of interface for receiving the user instruction may be provided.

At step 404, a determination is made whether the user instruction received requires manipulation of a display associated with the loop 106. The determination may be made by the media engine 104 (FIG. 1) or by any other component associated with media engine 104 or the loop 106. The display may comprise one or more items of the media 108, as discussed herein. Accordingly, the determination at step 404 may include assessing whether the user instruction requires manipulation of the entire loop 106 or manipulation of the media 108 being played within the loop 106.

At step 406, if the user instruction requires manipulation of the display associated with the loop 106, displayable features associated with the loop are adjusted in accordance with the user instruction. For example, if the user instruction comprises “zooming out” an item of the media 108, the media 108 may be adjusted to display a “zoomed out” view. The displayable features may be adjusted in any manner according to various embodiments.

At step 408, the loop 106 is displayed with the adjustments. Thus, for example, the “zoomed out” view of the media items(s) may be displayed to the user as part of the loop 106 or any other display may be provided according to the user instruction. In one example, the user instruction comprises clicking an item of the media 108. The user instruction may cause another loop to open (e.g. a subloop) or a universal record locator (URL) to be executed to view a web page. Any type of display, adjustment to the display, and so on may be provided in accordance with the user instruction.

At step 410, if the user instruction does not require manipulation of the display associated with the loop 106, the loop 106 is manipulated according to the user instruction. As discussed herein, the user instruction may include an instruction to manipulate and/or alter at least one of the one or more items of the media 108 comprising the loop(s) 106.

Alternatively, the user instruction may include an instruction to manipulate and/or alter the loop 106, itself. If the instruction comprises manipulating the loop(s) 106, the loop(s) 106 may be manipulated accordingly, in response to the user instruction. For example, the user instruction may include moving the location of the loop(s) 106 and the loop player 202 (FIG. 2) playing the loop(s) 106 on a display device associated with the user. The loop(s) 106, the loop player 202, the items of media 108, and/or any other items associated with the loop(s) 106 may be manipulated according to the received user instruction.

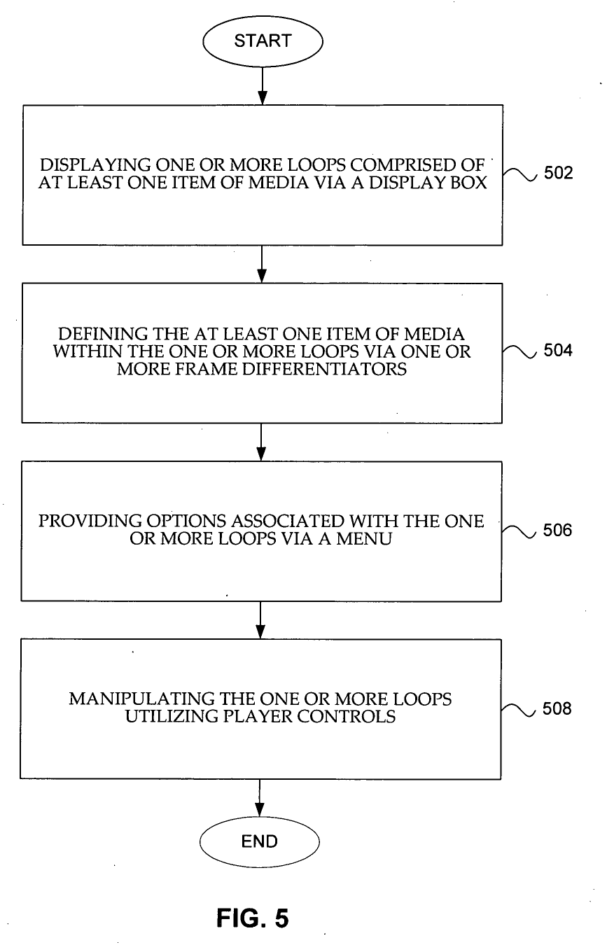

FIG. 5 illustrates a flowchart of an exemplary process for providing an interface for a loop. At step 502, one or more loops comprised of at least one item of media are displayed via a display box. The display box may comprise the loop(s) 106 (FIG. 1) scrolling across a display device associated with a user. The one or more items of media, such as the media 108 (FIG. 1) discussed herein, are displayed within the scrolling loop(s) 106. One or more loops 106 may comprise the display box, such as when a first loop(s) 106 scrolls adjacent to a second loop 106 across the display device. Any type of display box may be provided according to various embodiments. Further, any type of media, organization of the media, and so forth may be provided within the loop(s) 106.

At step 504, the at least one item of media 108 is defined within the one or more loops 106 via one or more frame differentiators. For example, in FIG. 2, the “Surfing Buddies” item of media 206 (FIG. 2) is differentiated from the “Lee Family Photos” media 206 by frame differentiators. The frame differentiators may be comprised of any display that separates and/or distinguishes one item of media 208 from another item of media 208 within the loop(s) 204 (FIG. 2). In one embodiment, a user may select a type of frame differentiator to distinguish the at least one item of media in the loop(s) 106 from the other items of media.

In exemplary embodiments, loop differentiators are provided for distinguishing between a plurality of loops 106 playing on the same loop player 202 (FIG. 2). For example, the loop differentiators may demarcate when one loop 204 in the loop player 202 begins and ends.

At step 506, options associated with the one or more loops 204 are provided via a menu. The menu may include any type of options. For example, the menu may offer settings options, help options, options for creating new loops 204, and so forth. Further, any type of interface for presenting the menu may be provided, such as a drop down menu, a page comprising buttons for providing the options, and so on.

At step 508, the one or more loops 204 are manipulated utilizing player controls 208 (FIG. 2). As discussed herein, the loop(s) 204 can be manipulated via one or more player controls 208, such as pause, forward, stop, and so forth. Any type of display box, frame differentiators, menus, options, and/or player controls 208 may be provided in association with the loop(s) 204.

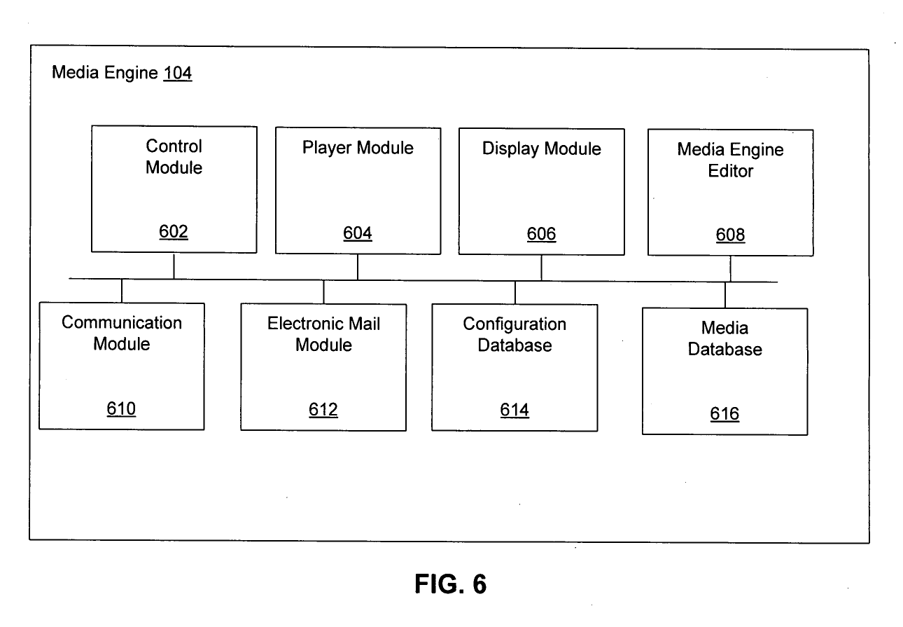

Referring to FIG. 6, a diagram for an exemplary media engine 104 is shown. A loop control module 602 manipulates the media 108 (FIG. 1) and constructs the loop(s) 106 (FIG. 1) from the media 108. The loop(s) control module 602 provides a default speed at which the loop(s) 106 plays. In a further embodiment, a user can specify the speed for playing the loop(s) 106 or adjust the speed from the default speed. The loop control module 602 may coordinate with the content provider 116 (FIG. 1) to insert specific content into the loop(s) 106 at specific times or in specific time intervals.

A player module 604 plays the loop(s) 106. The player module 604 may be utilized to control a direction and a speed at which the loop(s) 106 plays. The player module 604 may have a default direction, which may be changed by the user.

A display module 606 provides a graphical user interface (GUI) for allowing the user to interact with logic of the media engine 104. For instance, the display module 606 allows the user to interact with the media engine 104 to read and write the media 108. In other words, the display module 606 allows the user to create, modify, and/or remove the media 108 and/or the loop(s) 106 by choosing from on-screen selections and/or manipulating on-screen items. The display module 606 may also execute the media 108 from within a window, display the media 108 alone or as part of the loop(s) 106, and/or perform any functions related to display and user interaction with the display.

As discussed herein, the display module 606 allows the user to drag and drop the media 108 into the loop(s) 106 and remove the media 108 from the loop(s) 106. The user can drag and drop the media 108, click a button, or initiate a voice command to send the media 108 changes to the media engine 104.

Any type of display module 606 is within the scope of various embodiments. For instance, the display module 606 need not present a typical visual display, but may be a text-based display module for allowing the user to interact with logic of the media engine 104 based on text command lines.

A media engine editor 608 allows the user to make adjustments to the media 108. For example, the user can use the media engine editor 608 to resize the media 108, rotate the media 108, configure the media 108, format the media 108, and so forth. For instance, the user may resize an image or change a font type of text associated with the media 108. Any type of editing may be accomplished using the media engine editor 608.

A communication module 610 allows the media engine 104 to utilize components of the client 102 for communicating with the server 112 to send and receive updates for the loop(s) 106 running in the media engine 104, and to transfer any other data between the media engine 104 and the server 112.

An electronic mail interface 612 may be provided as a communications interface for electronic mails. Any type of electronic mail interface 612 may be provided. The electronic mail interface 612 may be utilized for sending the loop(s) 106, the media 108, metadata, or identifiers associated with the loop(s) 106 and/or the media 108 directly to other users.

A configuration database 614 may be utilized to store the one or more identifiers associated with the media 108 and/or the loop(s) 106. As discussed herein, when the loop(s) 106 is created using the media 108 or updates to the loop(s) 106 are provided, an identifier is assigned to the loop(s) 106 or the media 108. In further embodiments, the media 108 in the loop(s) 106 is assigned an identifier that is unique within the loop(s) 106.

The configuration database 614 may store any type of data related to the loop(s) 106, such as information regarding a host computer system, type and quality of an attached network, communications performance, registration information for the client 102, version number for the loop(s) 106 and the media 108 comprising the loop(s) 106. Any type of configuration database 614 may be utilized in accordance with various embodiments. As discussed herein, in one embodiment, the identifier is stored on the server 112 and/or in the configuration database 614. In alternative embodiments, the configuration database 614 may comprise more than a database. In yet a further embodiment, the configuration database 614 may be located outside the media engine 104, but be coupled thereto. It should be noted that the configuration database 614 and the media database 616 may comprise a single database.

A media database 616 may be provided for storing the media 108. In one embodiment, the content from the content provider 116 is stored in the media database 616. Any process for storing the media 108 may be utilized in association with the media database 616. For example, a hash function may be utilized to index and retrieve the media 108 in the media database 612 or from one or more other storage mediums.

Although the media engine 104 is described as including various components, the media engine 104 may include more components or fewer components than those listed and still fall within the scope of embodiments of the invention. For example, the media engine 104 may also include a media cache/buffer for short term storage of the media 108, an input/output (I/O) component for receiving and sending data at the client 102, a contact database for storing information associated with contacts, a user activity component for tracking activity of the user with respect to the media 108 and/or the loop(s) 106, and so forth.

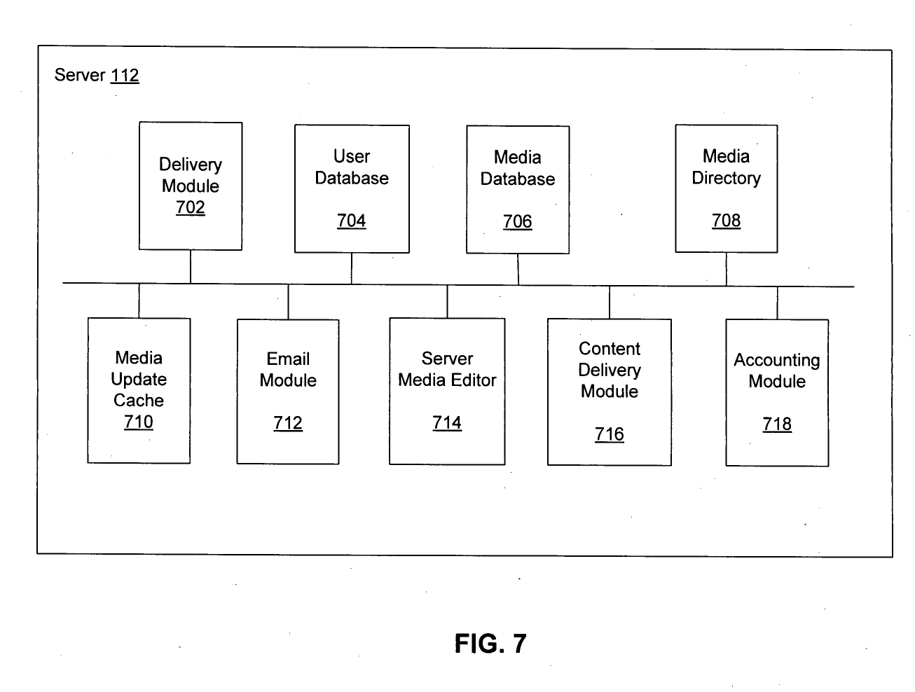

FIG. 7 illustrates exemplary components associated with the server 112 in accordance with one embodiment. A delivery module 702 may be provided for delivering the loop(s) 106 (FIG. 1), and the media 108 (FIG. 1) that comprise the loop(s) 106, as well as the identifiers assigned to the loop(s) 106 and the media 108 to clients.

In one embodiment, the media 108 is provided to the media engine 104 for creating the loop(s) 106. The media engine 104 then requests the server 112 create the loop(s) 106 with the media 108. Alternatively, as discussed herein, the media engine 104, itself, may create the loop(s) 106. The server 112 and/or the media engine 104 can assign an identifier to the loop(s) 106 and to each of the one or more items of media 108 comprising the loop(s) 106. If the server 112 creates the loop(s) 106 or maintains a master copy of the loop(s) 106, the server 112 can deliver the loop(s) 106 to the media engine 104 via the network 110, as discussed herein. However, any manner of delivering the loop(s) 106 to the media engine 104 is within the scope of various embodiments.

A user database 704 may be provided for storing user information, such as first and last names, electronic mail addresses, user identifiers, and so on. The user database 704 may also store information associated with the loop(s) 106 that the user created or received from other users. Based on the identifiers from the loop(s) 106, the user database 704 can provide the media 108 as updates to the appropriate loop(s) 106 in the loop players 104 running on the client 102 or the client(s) 114. Optionally, a user may be required to register certain information with the server 112 before the server 112 will provide the loop(s) 106 with the media 108 to the loop player(s) 202 (FIG. 2) associated with the user. Alternatively, the user may be required to register in order to receive the identifier for the media 108 and/or the loop(s) 106.

A media database 706 may also be provided for storing the media 108 the loop(s) 106 and/or any metadata or configuration information associated with the loop(s) 106 and/or the media 108. As discussed herein, the media 108 and/or the loop(s) 106 may include, for example, multimedia, photographs, sounds, music, pictures, streaming media, animation, movies, and graphics. Any type of media 108 may comprise the loop(s) 106.

A media directory 708 may be provided for indexing the media 108 stored in the media database 706. For example, in one embodiment, the media directory 708 may allow the loop(s) 106 and/or media 108 to be retrieved that have the word “fishing” in their titles or descriptions. Any indexing and searching by the media directory 708 on any information or metadata associated with the loop(s) 106 or the media 108 is within the scope of various embodiments.

A media update cache 710 stores the media 108 that is utilized to update, or otherwise modify, the loop(s) 106.

An electronic mail module 712 sends electronic mail for the user at the client 102 to the one or more other users at the client(s) 114, providing the users at the client(s) 114 with information for retrieving or constructing the loop(s) 106 and/or the media engine 104.

A server media editor 714 may be provided for modifying the media 108. The user can modify the media 108 utilizing the server media editor 714 via the server 112 rather than, or in addition to, the media engine editor 608 (FIG. 6). For example, the server media editor 714 may be used to resize photos, rotate photos, remove red eye from photos, correct color balance, cleanse the media 108 of viruses, and so forth.

As discussed in FIG. 1, a content provider 116 may be coupled to the server 112. Alternatively, the function of the content provider 116 may be performed by a content delivery module 716 within the server 112. The content delivery module 716 provides advertising and/or any other type of content to be included as one or more items of the media 108 within the loop(s) 106.

In one embodiment, the advertising and/or content from the content delivery module 716 may be provided based on an analysis of the user of the loop(s) 106. For example, an advertisement for toothpaste may be provided to a user with family related loops 106. However, any manner of determining the advertising and/or the content to be provided by the content delivery module 716 to the loop(s) 106 may be employed, such as arbitrarily choosing the advertising and/or the content.

In one embodiment, the media 108 may comprise more than one advertising media inserted into the loop(s) 106. As discussed herein, the content provider 116 and/or the content delivery module 716 may dictate how frequently the advertising media, or other content, appears. For instance, the advertising media may appear twice in the loop(s) 106, once for every five items of the media 108 in the loop(s) 106, and so on.

A commercial loop(s) 106 may also be created utilizing the content delivery module 716. The commercial loop(s) 106 may include media with embedded music, streaming video, audio, and/or other multimedia effects. A user may choose to allow the commercial loop(s) 106 to play on a display device associated with the user's client 102.

The server 112 may also include an accounting module 718. The accounting module 718 can track the media 108 within the loop(s) 106, and track the frequency and type of interaction each of the users has with the loop(s) 106 on the media 108. Specifically, the accounting module 718 is useful for tracking the interaction between the user and the advertisement media included within the loop(s) 106. Accordingly, the accounting module 718 can track monies due to a provider of the advertising media based on user interaction with the advertising media.

Although the server 112 has been described as including various components, fewer or more components may comprise the server 112 in accordance with various embodiments. For instance, the server 112 may also include a search engine component, or a communications interface.

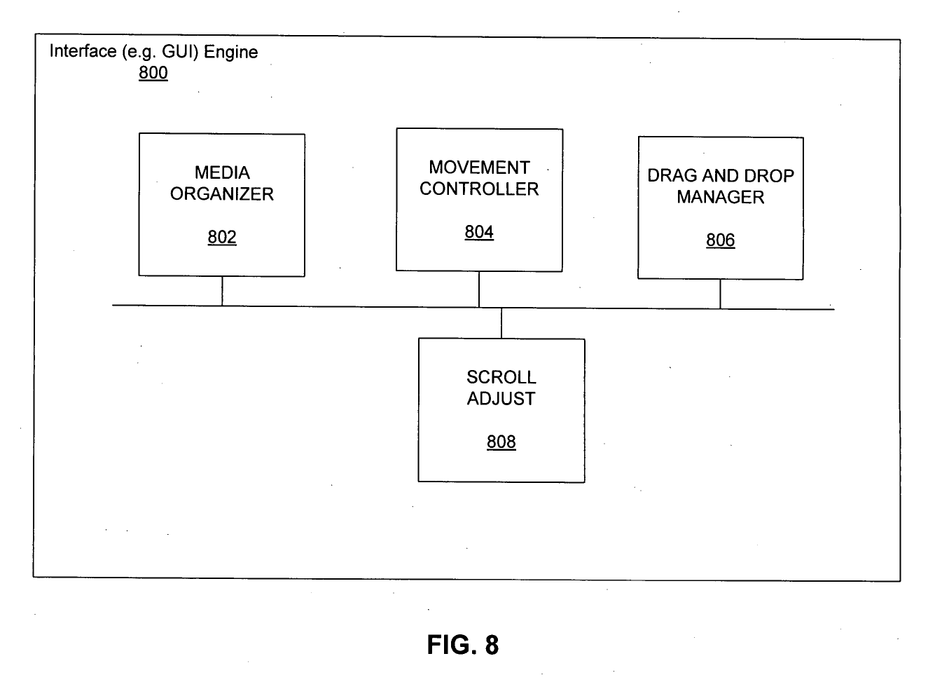

Turning now to FIG. 8, an exemplary graphical user interface (GUI) engine 800 for providing access to functions related to the media engine 104 (FIG. 1) is shown. In one embodiment, the GUI engine 800 is the display module 604 (FIG. 6). A media organizer 802 allows a user to organize the media 108 (FIG. 1) in the loop(s) 106 (FIG. 1). For example, the user can provide photos to the media organizer 802 via a drag and drop function, a keystroke, etc., and the media organizer 802 can automatically organize the photos according to default parameters or parameters specified by the user. The default parameter may be, for instance, to organize the photos according to dates associated with the photos. The user can specify any parameters, such as date, size, event, and so forth, for the media organizer 802 to use in arranging the media 108.

A movement controller 804 provides the user with a mechanism to regulate the pace of the loop(s) 106, as discussed herein, as it scrolls across a display device associated with the client 102. For example; the user may specify that the loop(s) 106 should scroll across the display device at a rate of one display device pixel per tenth of a second. The movement controller 804 also allows the user to specify the direction the loop(s) 106 should scroll across the display device of the client 102. For example, the user may specify that the loop(s) 106 should scroll left to right across the display device. Any manner of allowing the user to adjust the pace may be provided. For instance, the user may enter the scroll time into a box, move a slider between a slowest pace and fastest pace, select from scroll paces from a drop down menu, and so on.

A drag/drop manager 806 provides a mechanism for the user to modify the loop(s) 106 in a single drag and drop action. Thus, the user can drag one or more items of the media 108 into the loop(s) 106. The drag/drop manager 806 communicates the user action and information to other components/modules associated with the media engine 104 for automatically updating the loop(s) 106 to include the dropped media 108. As discussed herein, when the user performs this single act of dragging and dropping the media 108 into the loop(s) 106, one or more other loop(s) 106 that share the identifier are also updated with the dropped media 108. As discussed herein, the other loop(s) 106 may reside in other loop players 202 (FIG. 2) at the client(s) 114. Conversely, the user can drag one or more items of the media 108 away from the loop(s) 106, in order to remove the items. The loop(s) 106 that share the same identifier are also updated to no longer include the media 108 dragged away from the loop(s).

A scroll adjust 808 option may also be provided via the GUI engine 800. The scroll adjust 808 allows the user to manipulate the loop(s) 106 as they scroll across a display device. For instance, as the loop(s) 106 scrolls across the display device, the user can grab the loop(s) 106 with a mouse, keystroke, etc., and move the loop(s) 106. The user can stop the scrolling, slow down the scrolling, speed up the scrolling, and so forth by clicking on, moving, etc. the loop(s) 106, itself. The user can choose which of the loop(s) 106 and/or how many of the loop(s) 106 the user wants to scroll on the user's display device at one time.

Although an exemplary graphical user GUI engine 800 has been described, any type of graphical user interface engine with any type of functionality is within the scope of various embodiments. For example, the GUI engine 800 may include mechanisms for allowing functionality such as creating another loop when the user selects the one or more items of the media 108 comprising the loop(s) 108, displaying a larger image when the user selects the one or more items of the media 108 in the loop(s) 108, dragging and dropping the entire loop(s) 108 from one media engine 104 to another media engine 104, creating a new empty loop 108 from when the user selects an item of the media 108 in the loop(s) 108, sending an electronic mail message to other users that contains a copy of the entire loop(s) 108 or information related to specific loops 108, providing the ability to search for various loops 108 associated with the client 102, client(s) 114, and/or stored in a publicly accessible media directory 608, and so forth.

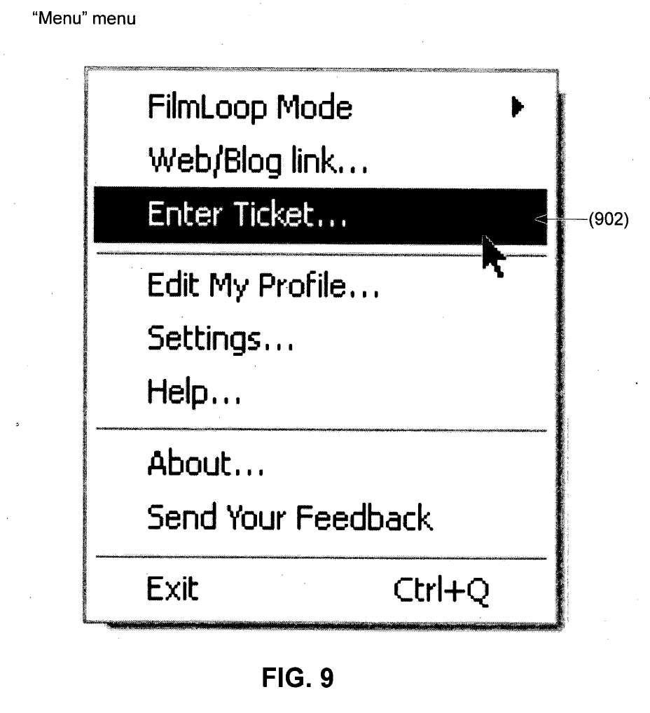

Referring to FIG. 9, an exemplary drop down menu 900 is shown. An “enter ticket” option 902 is highlighted. The “enter ticket” option 902 allows a user to provide an entry associated with a loop(s) 106 in order to obtain the loop(s) 106 associated with the entry. The entry may comprise the identifier for the loop(s) 106 and/or the media 108 within the loop(s) 106 or the entry may be associated with the identifier for the loop(s) 106 and/or the media 108. Any type of entry may be provided. In one embodiment, the user can enter a password, a text string, or any other data for obtaining the loop(s) 106.

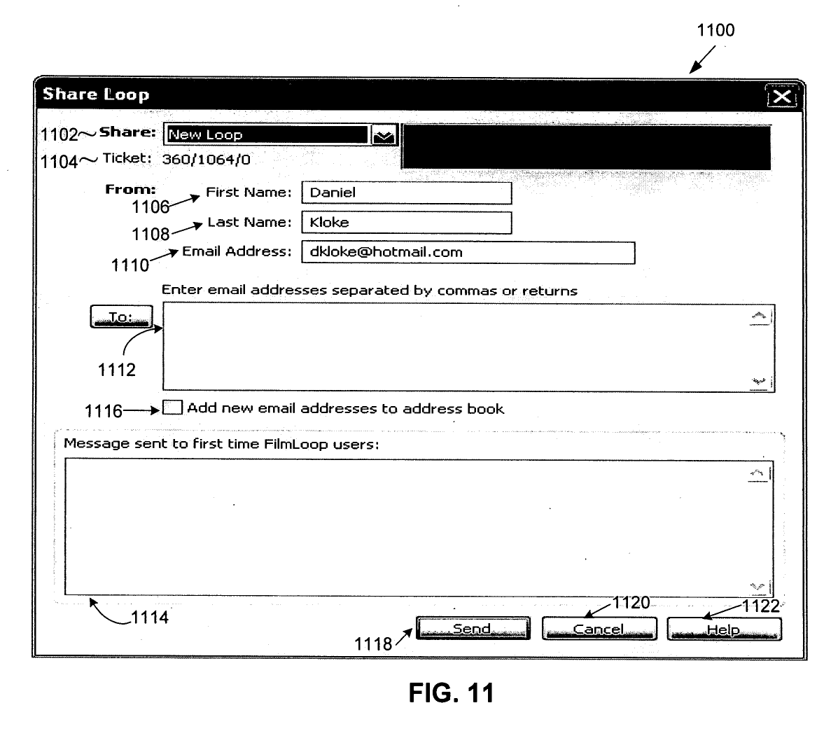

In exemplary embodiments, the user selects a share loop option (discussed in connection with FIG. 11). The user can then enter email addresses associated with other users with which the user wishes to share the particular loop(s) 106. When the other users receive an email, a ticket number is included in the body of the email. The ticket number may be included anywhere in the email, according to some embodiments, such as in the subject line, or embedded in an image file that is included in the body of the email. The user provides the ticket number to the loop player 202 (i.e. the media engine 104). In one embodiment, the user enters the ticket number into a text box provided by the loop player 202. In another embodiment, the user clicks on the ticket number to provide it to the loop player 202. Any mechanism for providing the ticket number to the media engine 104 and/or the loop player 202 is within the scope of some embodiments. After the user provides the ticket number, or other identifier, to the loop player 202 (for example, types it into the “enter ticket” option 902), the shared loop 106 will appear on a display device associated with the user. The shared loop 106 may appear adjacent to loops 106 played by the same loop player (FIG. 2) or as a separate loop 106 played by another loop player 202 on the same display device.

If the user does not possess any loop(s) 106 and/or the media engine 104, the media engine 104 and the shared loop 106 may be automatically downloaded onto a computing device associated with the user in response to the user entering data into the “enter ticket” option 902. For example, the user may select the “enter ticket” option 902 from a website that provides the loop(s) 106 in response to receiving the email. Components associated with the website may then download the media engine 104 and the shared loop(s) 106 to the computing device associated with the user in response to receiving the entry from the user in association with the “enter ticket” option 902.

A “loop mode” option 904 may be provided. The “loop mode” option 904 may provide options for displaying the loop(s) 106. For example, the loop(s) 106 can be displayed as the standard loop(s) 106 that scrolls across a display device, as a miniature version of the loop(s) 106, as a screen saver for a computing device, as wallpaper for a computing device, and so forth. Any type of display option may be provided via the “loop mode” option 904.

A “web/blog link” option 906 is provided as part of the drop down menu 900. The “web/blog” option 906 provides the user with a URL address or codes to obtain the loop(s) 106 and/or the media 108 in the loop(s) 106 at a remote location. In one embodiment, the user includes the URL address or codes in the source code of an internet web page so that viewers of the web page can obtain the loop(s) 106.

An “edit my profile” option 908 may also be provided. The “edit my profile” option 908 allows a user to edit and/or submit registration data, which may then be associated with the loop(s) 106 and/or the media engine 104. For example, the user's name, email address, birthday, gender, zip code, telephone number, address, and/or any other data associated with the user may be provided via the “edit my profile” option 908.

A “settings” option 910 is provided as part of the drop down menu 900. Any type of settings for a computing device associated with a user, the media player 104, the loop(s) 106, or the media 108 may be adjusted via the “settings” option 910. For example, the configuration of the loop player 202 may be established using the “settings” option 910. Connections, memory settings, and desktop display options, for example, may be established utilizing the “settings” option 910.

A “help” option 912 may be provided for displaying instructions associated with the loop(s) 106 and/or the media engine 104. An “about” option 914 may display copyright information and/or properties associated with the media engine 104 and/or the loop(s) 106. A “send your feedback” option 916 may be provided for the user to offer feedback related to the loop(s) 106 and/or the media engine 104. An “exit” option 918 is provided for closing the media engine 104 playing the loop(s) 106, so the loop(s) 106 no longer appear on a display device associated with a user.

As shown in FIG. 9, various key strokes may be displayed so that the user may utilize the key strokes rather than selecting the options from the drop down menu 900 using a mouse pointer. Although various options have been described in connection with the drop down menu 900, fewer or more options may be provided and still fall within the scope of various embodiments. Further, menus other than or, instead of, the drop down menu 900 may be provided for presenting options associated with the loop(s) 106.

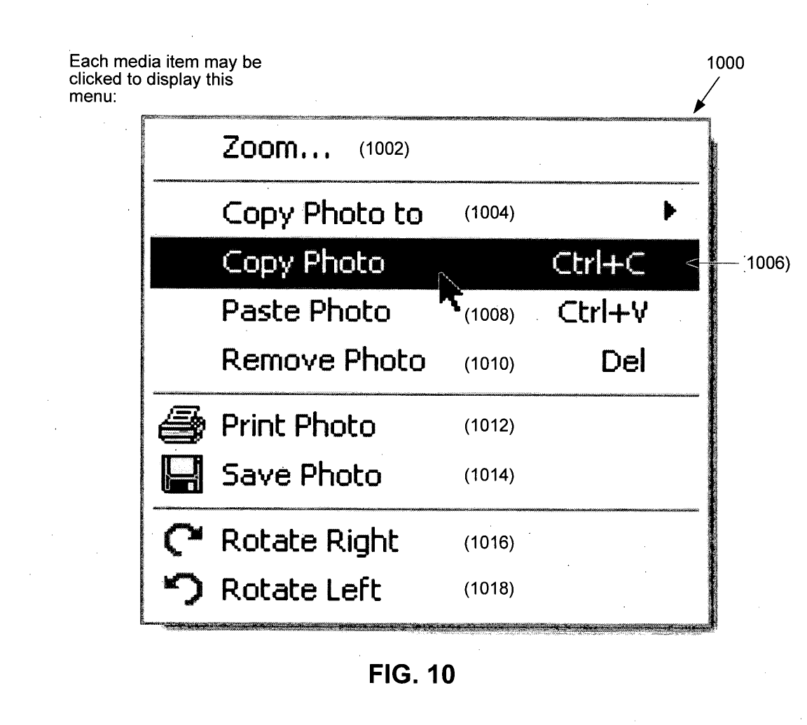

Turning now to FIG. 10, an exemplary menu 1000 associated with an item of media is shown. The exemplary menu 1000 is displayed when a user clicks on the media 108 (FIG. 1) within the loop(s) 106 (FIG. 1). A “zoom” option 1002 allows the user to view a larger version of the media 108.

A “copy photo to” option 1004 provides for copying the media 108, which may comprise a photo or any other image, data, and so forth. The “copy photo to” option 1004 allows the user to specify where the user wishes to store the copied media 108.

A “copy photo” option 1006 is highlighted in FIG. 10. The “copy photo” 1006 option allows a user to copy the media 108 presented in the loop(s) 106. As discussed herein, the media 108 may comprise a photo, an image, or any other type of data according to exemplary embodiments.

A “paste photo” option 1008 may be provided for pasting a photo that comprises the media 108, while a “remove photo” 1010 option may be provided for eliminating the photo from the loop(s) 106 so the photo no longer appears as part of the loop(s) 106.

A “print photo” option 1012 provides for printing a photo. A “save photo” option 1014 provides for saving a photo to a file, directory, or storage medium.

The media 108 may be rotated in any direction, such as via a “rotate right” option 1016, a “rotate left” option 1018, or any other rotation option that may be provided via the menu 1000.

As shown in FIG. 10, various key strokes may be displayed so that the user may utilize key strokes rather than selecting the options from the exemplary menu 1000 using a mouse pointer. Although various options have been described in connection with the exemplary menu 1000, fewer or more options may be provided and still fall within the scope of various embodiments. Further, menus other than or instead of the exemplary menu 1000 may be provided for presenting options associated with the media 108.

FIG. 11 shows an exemplary share loop screen 1100 for sharing a loop. As discussed herein, a user may select a “share” option from the loop player 202 (FIG. 2), from a menu, or from any other icon displayed in association with the loop(s) 106 (FIG. 1) and/or the loop player 202. Once the “share” option is selected, the share loop screen 1100 appears.

A drop down share menu 1102 may be provided for selecting the loop(s) 106 the user wants to share. Any type of mechanism for selecting the loop(s) 106 the user wants to share may be provided according to various embodiments.

A ticket identifier 1104 displays an identifier that may be forwarded to the user. The user may enter the ticket number to receive the shared loop(s) 106, as discussed herein.

A first name entry 1106 may be provided, as well as a last name entry 1108, and/or an email address entry 1110 associated with the user who wants to share the loop(s) 106. Although text boxes are exemplified in FIG. 11 for receiving data related to the user who wants to share the loop(s) 106 and/or any other users with whom the user wants to share, any type of mechanism for receiving data may be provided. In a further embodiment, various entries (e.g. first name entry 1106, last name entry 1108, email address entry 1110) may be automatically filled in by the media engine 104.

An email entry 1112 is provided for entering the email addresses of one or more other users with whom the user wants to share the loop(s) 106. A message entry 1114 may also be provided for entering a message to forward to the one or more other users along with the ticket identifier 1104. As discussed herein, although a ticket number is provided as the ticket identifier 1104 in FIG. 11, any type of identifier may be provided in association with the loop(s) 106.

An adding new email addresses check box 1116 may be provided for adding email address to an address book associated with the user. Any type of check boxes and/or other options may be provided.

The share loop screen 1100 may include various buttons, such as a “send” button 1118, a “cancel” button 1120, and/or a “help” button 1122. Further, options may be provided in association with display items other than buttons according to various embodiments.

The process of sharing loops is described in further detail in co-pending U.S. application Ser. No. ______, entitled “Systems and Methods for Single Act Media Sharing,” filed on Jul. 1, 2005, co-pending U.S. application Ser. No. ______, entitled “Systems and Methods for Sharing Loops,” filed on Jul. 1, 2005, and co-pending U.S. application Ser. No. ______, entitled “Loop Channels,” filed on Jul. 1, 2005, which is incorporated by reference.

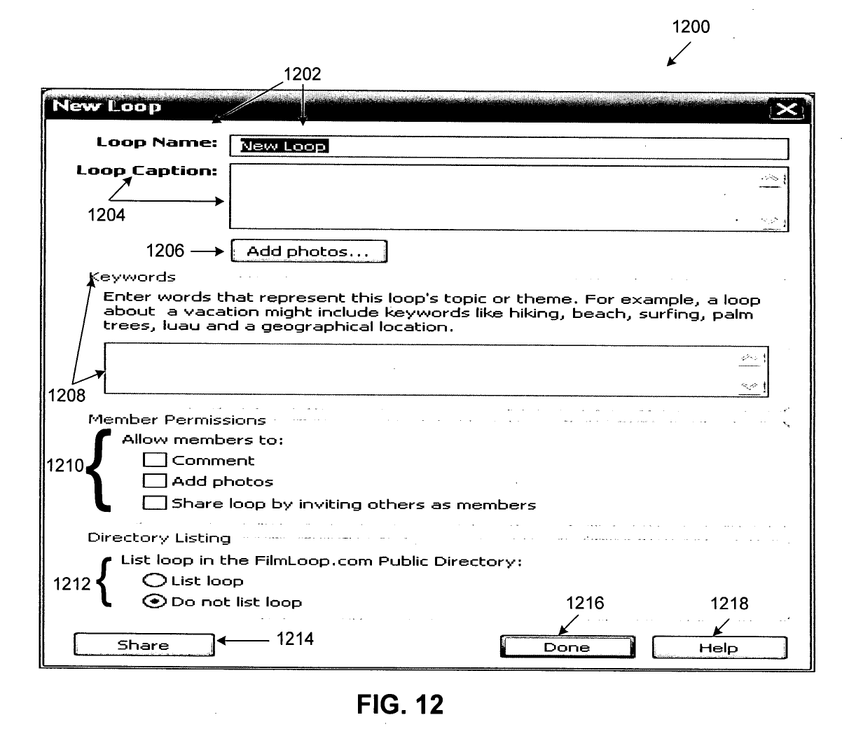

Referring to FIG. 12, an exemplary new loop screen 1200 for generating a new loop is shown. A user may select a “new loop” option from the loop player 202 (FIG. 2) display, from the menu associated with the loop player 202 discussed herein, and so forth. The new loop screen 1200 allows the user to enter data related to creating a new loop(s) 106.

A loop name entry 1202 is provided for receiving data related to a name for the new loop. For example, a user may enter “2005 family reunion photos” or any other title, subject matter, and so forth into the loop name entry 1202. The loop name entry 1202 may comprise a title box according to some embodiments for entitling the loop(s) 106.

A loop caption entry 1204 provides space for entering data related to the new loop. For example, a user may enter text describing an event associated with the new loop. The loop caption entry 1204 comprises a comment box, in some embodiments, for providing comments associated with the loop(s) 106.

An add photos option 1206 allows a user to select photos 1206, or any other media, from a directory, a website, or any other source to include as part of the new loop.

A keywords entry 1208 is provided for allowing a user to enter keywords associated with the new loop. The data entered into the loop name entry 1202 and/or the loop caption entry 1204 may comprise the keywords entry 1208 according to some embodiments. The keywords entry 1208 data may be utilized to later search for the new loop. The keywords entry 1208 may comprise a comment box, in some embodiments, for entering comments to associate with the loop(s) 106.

A member permissions section 1210 may provide permissions related to the loop(s) 106. For example, the user can set the member permissions to allow other users (i.e. members) to comment, add photos, or share the loop by inviting others as members. Any type of permissions may be set according to various embodiments, such as allowing other users to remove media 108, to modify the media 108 existing within the loop(s) 106, and so forth.

A directory listing 1212 section maybe provided for selecting options associated with a public directory for the loop(s) 106. In FIG. 12, a user may choose to list the loop(s) 106 in the public directory. According to exemplary embodiments, any type of directories may be listed in the directory listing section 1212. Furthermore, any type of permissions may be associated with the directories according to various embodiments.

In one embodiment, a user may search for the loop(s) 106 in directories based on keywords in the loop name entry 1202, keywords in the loop caption entry 1204, and/or keywords in the keywords entry 1208, as discussed herein. The loop(s) 106 may be listed according to an alphabetical order of the keywords in the loop name entry 1202, keywords in the loop caption entry 1204, and/or keywords in the keywords entry 1208. In one embodiment, each directory may have a name associated with the directory, and the directory may be selected and browsed based on the directory name.

In one embodiment, the loops 106 are categorized into directories with names indicating subject matter associated with the loops 106. Any type of category may be associated with the loop(s) 106. For example, in one embodiment, the loops 106 are categorized according to subject matter, such as whether the media 108 in the loop(s) 106 comprises or mostly comprises audio, documents, search results, website information, commercial data, images, photos, and so forth.

Once the data has been selected, entered, and so on in the new loop screen 1200, the user can select the “share” button 1214 to share the loop 106 and/or the “done” button 1216 to complete generation of the loop 106. The user may also select the “help” button 1218 in order to view help information related to the new loop screen 1200.

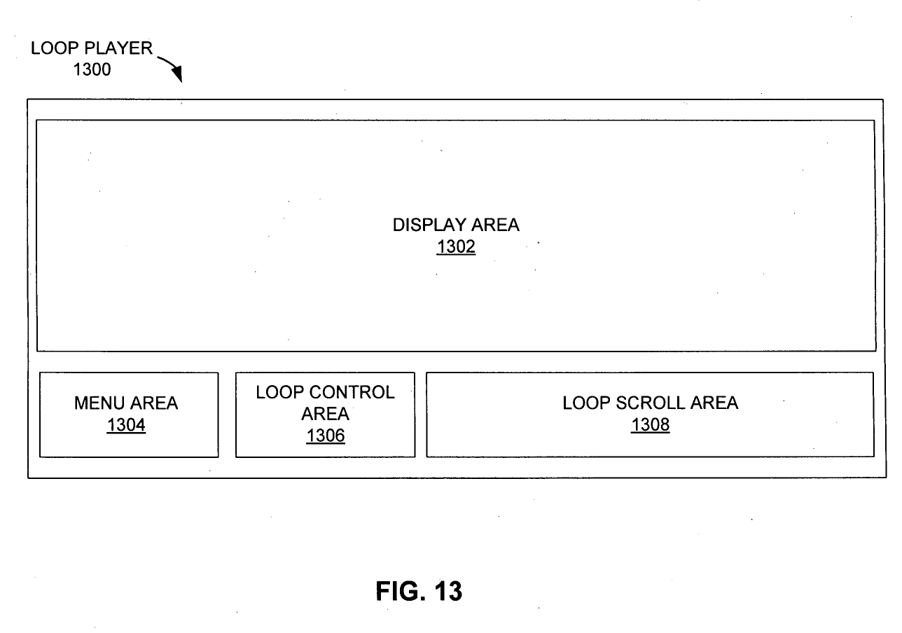

Turning now to FIG. 13, an exemplary schematic diagram of functions related to an exemplary loop player 1300 for playing a loop is shown. A display area 1302 provides an area for displaying the media 108 in the loop(s) 106. As discussed herein, frame differentiators may be provided for distinguishing the media 108 from one another. The loop(s) 106 with the media 108 scrolls across a display device in the display area 1302.

More than one loop(s) 106 may be scrolled across the display area 1302 of the media engine 104 and/or more than one loop player 1300 may display each of the loop(s) 106 or a grouping of the loop(s) 106. For example, one loop player 1300 may display one or more loops 106 categorized as family photo loops while another loop player 1300 may display one or more loops 106 categorized as scenic images loops.

A menu area 1304 of the loop player 1300 may provide various options related to the loop(s) 106 and/or the media 108. For example, a new loop option may be selected from the menu area 1304, as discussed herein. Any type of menu options may be provided in the menu area 1304 according to various embodiments.

A loop control area 1306 provides control options, such as the player controls 208 (FIG. 2) discussed herein. For example, a user can pause the loop(s) 106 utilizing options within the loop control area 1306.

A loop scroll area 1308 may be provided for manipulating the scroll area associated with the loop(s) 106. For example, the loop scroll area 1308 may be utilized to adjust a speed associate with the loop(s) 106. Any adjustment, manipulation, and so forth may be made to the loop(s) 106 utilizing the loop scroll area 1308.

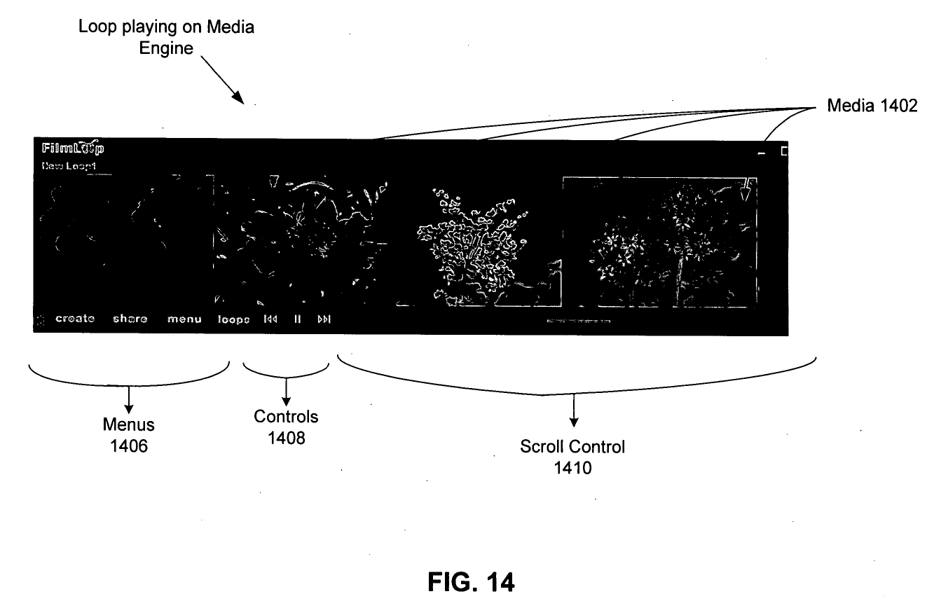

FIG. 14 shows a screen shot 1400 of an exemplary loop player 1400 playing an exemplary loop 1404. Media 1402 is provided in the loop 1404. Various menus 1406 are provided. Controls 1408 are provided for manipulating media 1402 within the loop 1404. A scroll area 1410 is also provided for adjusting a speed associated with the loop(s) 106, reversing the loop(s) 106, forwarding the loop(s) 106, and so on.

The above-described functions can be comprised of instructions that are stored on a storage medium. The instructions can be retrieved and executed by a processor. Some examples of instructions are software, program code, and firmware. Some examples of storage medium are memory devices, tape, disks, integrated circuits, and servers. The instructions are operational when executed by the processor to direct the processor to operate in accord with the invention. Those skilled in the art are familiar with instructions, processor(s), and storage medium.

While various embodiments have been described above, it should be understood that they have been presented by way of example only, and not limitation. For example, any of the elements associated with the loop(s) may employ any of the desired functionality set forth hereinabove. Thus, the breadth and scope of a preferred embodiment should not be limited by any of the above-described exemplary embodiments.

What is claimed is:

1. A system for providing an interface for interacting with a loop, comprising:
a display box configured for displaying one or more loops comprised of at least one item of media;
one or more frame differentiators configured for defining the at least one item of media within the one or more loops;
a menu configured for providing options associated with the one or more loops; and
player controls configured for manipulating the one or more loops.

2. The system recited in claim 1, further comprising a title box configured for receiving text to entitle the one or more loops.

3. The system recited in claim 1, further comprising at least one comment box configured for receiving text associated with the at least one item of media.

4. The system recited in claim 1, further comprising loop differentiators for defining at least one boundary of the one or more loops.

5. The system recited in claim 1, wherein the display box interacts with a loop player.

6. The system recited in claim 1, wherein the player controls comprise at least one of a play icon, a stop icon, a pause icon, a reverse icon, and a forward icon.

7. A method for providing an interface for interacting with a loop, comprising:
displaying one or more loops comprised of at least one item of media;
defining the at least one item of media within the one or more loops via one or more frame differentiators;
providing options associated with the one or more loops via a menu; and
manipulating the one or more loops via player controls.

8. The method recited in claim 7, further comprising receiving text via a title box to entitle the one or more loops.

9. The method recited in claim 7, further comprising receiving text via a comment box associated with the at least one item of media.

10. The method recited in claim 7, further comprising defining at least one boundary of the one or more loops via loop differentiators.

11. The method recited in claim 7, wherein a loop player scrolls the one or more loops across a display device.

12. The method recited in claim 7, wherein the player controls comprise at least one of a play icon, a stop icon, a pause icon, a reverse icon, and a forward icon.

13. A computer program embodied on a computer readable medium having instructions for a method for providing an interface for interacting with a loop, the method comprising:
displaying one or more loops comprised of at least one item of media;
defining the at least one item of media within the one or more loops via one or more frame differentiators;
providing options associated with the one or more loops via a menu; and
manipulating the one or more loops via player controls.

14. The computer program recited in claim 13 wherein the method further comprises receiving text via a title box to entitle the one or more loops.

15. The computer program recited in claim 13 wherein the method further comprises receiving text via a comment box associated with the at least one item of media.

16. The computer program recited in claim 13 wherein the method further comprises defining at least one boundary of the one or more loops via loop differentiators.

17. The computer program recited in claim 13, wherein a loop player scrolls the one or more loops across a display device.

18. The computer program recited in claim 13, wherein the player controls comprise at least one of a play icon, a stop icon, a pause icon, a reverse icon, and a forward icon.

19. A method for providing an interface for interacting with a loop, comprising:
providing one or more player controls associated with a loop player for manipulating a loop;
receiving at least one user instruction via the player controls; and
manipulating the loop according to the at least one instruction in a manner consistent with the one or more player controls at the interface.

20. The method recited in claim 19, wherein the one or more player controls comprise an icon for manipulating a direction associated with the loop.

21. The method recited in claim 19, wherein the one or more player controls comprise an icon for manipulating a speed associated with the loop.

22. The method recited in claim 19, wherein the interface further comprises one or more icons for allowing manipulation of the loop.

23. The method recited in claim 19, wherein manipulating the loop comprises removing one or more items of media from a plurality of media from the loop.

24. The method recited in claim 19, wherein manipulating the loop comprises adding at least one item of media to the loop.

25. The method recited in claim 19, wherein the one or more player controls comprise an icon for manipulating one or more items of media associated with the loop.

26. The method recited in claim 19, further comprising modifying an order associated with one or more items of media associated with the loop.

27. The method recited in claim 26, wherein modifying the order comprises moving at least one of the one or more items of media from a first location within the loop to a second location within the loop.
